(19) United States
(12) Patent Application Publication
(10) Pub. No.: US 2009/0274812 A1
(43) Pub. Date: Nov. 5, 2009

(54) DEVICE, APPLICATION OF THE DEVICE AND METHOD FOR MANUFACTURING A LIQUID FLAVOURING SUBSTANCE CONDENSATE

(75) Inventors: Michael Roloff, Oberweser-Arenborn (DE); Regina Peter, Brakel-Istrup (DE); Matthias Lutkenhaus, Uslar (DE)

Correspondence Address: CONNOLLY BOVE LODGE & HUTZ LLP, 1875 EYE STREET, N.W., SUITE 1100, WASHINGTON, DC, 20006, US

(73) Assignee: SYMRISE GmbH & Co. KG, Holzminden (DE)

(21) Appl. No.: 12/429,618

(22) Filed: Apr. 24, 2009

(30) Foreign Application Priority Data
Apr. 30, 2008 (DE) 10 2008 022 347.6

(51) Int. Cl. G01N 30/02; B01F 3/04

(52) U.S. Cl. 426/474; 261/78.2; 422/70

(57) ABSTRACT

The present invention concerns a device, a use of the device and a method for manufacturing a flavouring substance condensate containing or consisting of one or more flavouring substances, one or more reference substances, water and/or ethanol, as well as a method for sensorial assessment of the liquid flavouring substance condensate.

### CROSS-REFERENCE TO RELATED APPLICATION

This application claims benefit of priority to DE 10 2008 022 347.6, filed on April 30, 2008, which is incorporated herein by reference in its entirety.

### SCOPE OF THE INVENTION

The present invention concerns a device, a use of the device and a method for manufacturing a liquid flavouring substance condensate containing or consisting of one or more flavouring substances or one or more reference substances, water and/or ethanol, as well as a method for sensorial assessment of the liquid flavouring substance condensate.

### STATE OF THE ART

Aromas are usually a complex mixture of a number of sensorially active substances, for example plant extracts or natural, nature-identical or synthetic flavouring agents. Aroma compositions containing or consisting of sensorially active substances contain at least two different flavouring agents, which may be volatile (aromatic substances) or non-volatile (flavouring substances). In the human nose volatile aromatic substances can be perceived retronasally or orthonasally. The taste (gustatory) impressions of umami, salty, sour, sweet and bitter are perceived by interaction between the flavouring substances and the taste receptors on the tongue, and furthermore other sensorial impressions, such as, for example, prickling, cooling, burning, pungent or electrifying (tingling) effects may be perceived, which often are the result of trigeminal irritation. The sensorial taste impression of an aroma composition is basically influenced by the ratio of quantities of the sensorially active substances of an aroma composition, wherein the sensorial contribution of the individual flavouring agents is decisive rather the absolute quantities of these. The sensorially relevant flavouring agents contained in foods are often present in only small quantities and frequently are as yet not known, even though these flavouring agents make a significant contribution in terms of taste and/or smell, because of their high level of sensorial activity. An important assessment criterion is therefore the aroma value, defined as the quotient of a sensorially active flavouring agent to the smell or taste threshold value.

In the aroma industry a number of different sensorial assessment methods or devices are in use today for sensorial assessment. Preparation of the samples used for assessment in these is often very labour-intensive and time-consuming. Volatile solvent contents in sample extracts are often reduced by using a separate method. Sample mixtures are created by additional work steps. For the individual user it is extremely difficult, or almost impossible, to master the use of the large number of different devices and methods. He will therefore of necessity limit himself to the known and available devices and methods which, in certain cases, may lead to suitable devices and methods not being used. In the periodical Chemie in unserer Zeit 2003, 37, 388-401, or in the literature quoted therein, an article is published that provides an overview of this topic.

Regarding the search for flavouring and aromatic substances before now no high-throughput screening method for sensorial assessment of the test sub-compounds has been known, which can be used for rapid identification of new, sensorially interesting compounds. Therefore the systematic investigation of a natural substance extract these days involves the multi-stage separation and pre-treatment for purification and concentration of the individual compounds contained in the extract. In particular the preparation of samples for sensorial assessment in various test media takes a great deal of time. The artefact formation, instability or processing losses during isolation/mixing of aromatic and/or flavouring substances from/with complex matrices, however, can also lead to spurious smell or taste information continually presenting the analyst with new challenges. Therefore a number of different gentle extraction and isolation methods have been developed which in particular deal with specific problems individually.

For the separation by liquid chromatography of aroma compositions, eluates (mobile phase) are normally used, which can be mixed with water but which are harmful to health or toxic. Frequently used eluates are acetonitrile, methanol and tetrahydrofurane as well as mixtures of these with aqueous buffers or water. These solvents that are harmful to health must be removed before any sensorial evaluation. With the use of time-consuming, extractive or thermal methods for removing the solvent harmful to health a change in the composition of the components obtained by liquid chromatography often results. Causes of this are thermal and/or oxidative effects during treatment. The sensorial characteristics of components handled in this way often differ considerably from the original compositions. In WO 2006/111476 a method for separating olfactorily and/or gustatorily active components by means of high-temperature liquid chromatography (HTLC) and a process for the direct tasting of the components separated by this process are already known. In fact the device and the method according to WO 2006/111476 allow separation of several flavouring substances and direct on-line or synchronous determination of the aroma value of an individual flavouring substance and as a result its sensorial contribution, but the device and the method according to WO 2006/111476 do not allow the sensorial assessment of a flavouring substance with regard to its amplifying (synergic) or its reducing (masking) gustatory characteristics in relation to other flavouring substances contained in an aroma composition. A further disadvantage of this method is that the eluate of a separated flavouring agent, because of its distribution characteristics, can have an ethanol content of significantly more than 15% by weight in relation to the total weight of the eluate. An ethanol content of more than 15% by weight in relation to the total weight of the eluate, however, can firstly lead to an influence on the smell or taste receptors of a test person and thus to spurious information on the sensorial characteristics and secondly an ethanol content of more than 15% by weight, for a tasting of normally 5 ml per sample, can occasionally affect the awareness of the test person when tasting a number of samples, so that only very few tastings can be carried out in a day.

DE 3 941 533 A1 describes an interface for coupling a liquid chromatography system with a solid or gas phase detector. The interface according to the invention includes a nebuliser with thermal spray or other spray method, coupled to an evaporation chamber and a technical detector, for example a mass detector, wherein the temperature in the nebuliser is already raised to more than 100° C., in order to produce particularly small aerosol droplets and thus achieve a large surface area, so that in the subsequent evaporation step almost all the solvent is evaporated and a “dry” aerosol containing the inert gas and the particles of interest is passed on to the gas phase or solid phase detector for analysis. The disadvantage of the device or the method according to DE 3 941 533 A1 is that no sensorial evaluation can be carried out by a test person with regard to the taste characteristics of individual flavouring substances and in particular no amplifying (synergic) or reducing (masking) characteristics of one flavouring substance in relation to other flavouring substances contained in an aroma composition can be determined.

Evaluation methods using electronic sensor systems (“in vitro”) are also known. The disadvantage with these is that they are often not transferable to the taste or smell impression of humans.

The problem for the present invention is therefore to provide a device and a method for sensorial assessment of flavouring substances, which meet one or more of the following criteria:
rapid and simple production of a flavouring substance preparation containing one or more flavouring substances for direct sensorial assessment by a test person (in vivo), wherein the flavouring substances contained are (essentially) not adversely affected by the production process in terms of their taste impression,
on-line or synchronous sensorial assessment of the taste (tasting),
sensorial assessment of the amplifying (synergic) or reducing (masking) characteristics of a flavouring substance,
minimisation of the misjudgement of a taste impression due to the adverse effect on the taste receptors of the tongue of the ethanol content and/or
tasting of 2, 3, 4, 5 or more flavouring substance samples in a single day without occasional loss of awareness by the person due to the alcohol content.

### SUMMARY OF THE INVENTION

The object of the invention is solved by the subject matters of the invention according to the independent claims.

A first subject matter according to the invention concerns a device (1) for producing a liquid flavouring substance condensate that is suitable for sensorial assessment by a test person with two nebulisers (2, 2′), a mixing chamber (3), a separation chamber (4) and a condensation chamber (5), characterised in that
the first nebuliser (2) contains or consists of a liquid inlet (21), a gas inlet (22) and a connection to the mixing chamber (3), so that a liquid flavouring substance preparation containing one or more flavouring substances, water and/or ethanol by means of the liquid inlet (21) and an inert gas by means of the gas inlet (22) can be fed into the nebuliser (2) and the nebuliser (2) is suitable for nebulising the liquid and the inert gas into an aerosol feeding them in this way into the mixing chamber (3),
the second nebuliser (2′) contains or consists of a liquid inlet (21′), a gas inlet (22′) and a connection to the mixing chamber (3), so that a liquid reference preparation containing one or more reference substances, water and/or ethanol by means of the liquid inlet (21′) and an inert gas by means of the gas inlet (22′) can be fed into the nebuliser (2′) and the nebuliser (2′) is suitable for nebulising the liquid and the inert gas into an aerosol and feeding them in this way into the mixing chamber (3),
the mixing chamber (3) contains or consists of a condenser (31) and a connection to a separation chamber (4), wherein the mixing chamber (3) is arranged after the first and second nebulisers (2,2′) and is thus connected in such a way that the aerosols formed by the first and second nebulisers (2,2′) can be fed into the mixing chamber (3) separately and the evaporator (31) is suitable for converting part or all of the ethanol in the aerosols fed in partially or completely into the gas phase,
the separation chamber (4) contains or consists of a gas outlet (41) and a connection to the condensation chamber (5), wherein the separation chamber (4) is arranged after the mixing chamber (3) and is connected in such a way that the ethanol converted to the gas phase and the remaining aerosol can be fed into the separation chamber (4) and part or all of the ethanol gas phase can be removed from the device (1) via the gas outlet (41) and
the condensation chamber (5) contains or consists of a liquid outlet (51) and a condenser (52), wherein the condensation chamber (5) is arranged after the separation chamber (4) and is connected in such a way that the aerosol remaining in the separation chamber (4) following the partial or complete removal of the ethanol gas phase can be fed into the condensation chamber (5) and the condenser (5) is suitable for condensing the aerosol fed in fully or in part and the condensate can be removed from the condensation chamber (5) via the liquid outlet (51).

A second subject matter according to the invention concerns a method for producing a liquid flavouring substance condensate suitable for sensorial assessment of the amplifying or reducing flavouring substance characteristics by a test person containing or consisting of the following steps:
a) provision of a liquid flavouring substance preparation, containing or consisting of one or more flavouring substances, water and/or ethanol, and an inert gas,
b) provision of a liquid reference preparation, containing or consisting of one or more reference substances, water and/or ethanol, as well as an inert gas,
c) feeding of the liquid flavouring substance preparation from step a) through a liquid inlet (21) and the inert gas through a gas inlet (22) into a first nebuliser (2) by means of which the flavouring substance preparation and the inert gas are nebulised into an aerosol and in this way fed into a mixing chamber (3),
d) feeding of the liquid reference preparation from step b) through a liquid inlet (21′) and the inert gas through a gas inlet (22′) into a second nebuliser (2′) by means of which the reference preparation and the inert gas are nebulised into an aerosol and in this way fed into a mixing chamber (3),
e) conversion of part or all of the ethanol content of the aerosols fed into the mixing chamber (3) in step d) by means of an evaporator (31) into a gas phase,
f) passing of the aerosol formed in step e) into a separation chamber (4) connected to the mixing chamber (3) and with a gas outlet (41) and removal of part or all of the gaseous ethanol content from the separation chamber (4) through the gas outlet (41),
g) passing of the aerosol formed in step f) into a condensation chamber (5) connected to the separation chamber (4) and with a liquid outlet (51) and a condenser (52) and condensation of the aerosol by means of the condenser (52) into a flavouring substance condensate containing or consisting of the flavouring substance(s), the reference substance(s), water and/or ethanol and
h) removal of the flavouring substance condensate formed in step g) from the condensation chamber (5) through the liquid outlet (51).

A third subject matter according to the invention concerns a method for sensorial assessment of the amplifying and/or reducing taste impressions of one or more flavouring substances containing or consisting of the following steps:
i. production of a liquid flavouring substance condensate containing or consisting of one or more flavouring substances, one or more reference substances, water and/or ethanol according to the above method according to the invention and
ii. introduction of the flavouring substance condensate into the mouth of a test person for sensorial assessment of amplifying and/or reducing taste impressions of the flavouring substance(s) in the flavouring substance condensate.

A fourth subject matter according to the invention concerns a use of a device according to the invention for the production of a liquid flavouring substance condensate containing or consisting of one or more flavouring substances, one or more reference substances, water and/or ethanol.

A fifth subject matter according to the invention concerns a method for diluting a liquid flavouring substance preparation containing or consisting of the following steps:
a) provision of a liquid flavouring substance preparation, containing or consisting of one or more flavouring substances, water and ethanol with an ethanol content of >15% by weight with reference to the total weight of the flavouring substance preparation, and an inert gas,
b) provision of a diluent, containing or consisting of water and/or ethanol, wherein the ethanol content is ≦15% by weight with reference to the total weight of the solution, and an inert gas,
c) feeding of the liquid flavouring substance preparation from step a) through a liquid inlet (21) and of the inert gas through a gas inlet (22) into a first nebuliser (2) by means of which the flavouring substance preparation and the inert gas are nebulised into an aerosol and in this way fed into a mixing chamber (3),
d) feeding of the diluent from step b) through a liquid inlet (21′) and of the inert gas through a gas inlet (22′) into a second nebuliser (2′) by means of which the diluent and the inert gas are nebulised into an aerosol and in this way fed into the mixing chamber (3),
e) conversion of part or all of the ethanol content of the aerosol fed into the mixing chamber (3) in step d) by means of an evaporator (31) into a gas phase,
f) passing of the aerosol formed in step e) into a separation chamber (4) connected with the mixing chamber (3) and with a gas outlet (41) and removal of part or all of the gaseous ethanol content from the separation chamber (4) through the gas outlet (41),
g) passing of the aerosol formed in step f) into a condensation chamber (5) connected with the separation chamber (4) and with a liquid outlet (51) and condenser (52) and condensation of the aerosol by means of the condenser (52) into a flavouring substance condensate containing or consisting of the flavouring substance(s), water and ethanol, wherein the ethanol content is ≦15% by weight with reference to the total weight of the condensate and
h) removal of the flavouring substance condensate formed in step g) from the condensation chamber (5) via the liquid outlet (51).

A sixth subject matter according to the invention concerns a method for sensorial assessment of one or more flavouring substances containing or consisting of the following steps:
i. production of a liquid flavouring substance condensate containing or consisting of one or more flavouring substances, water and ethanol according to the fifth object according to the invention, wherein the ethanol content is ≦15% by weight with reference to the total weight of the condensate, and
ii. introduction of the flavouring substance condensate from step i) into the mouth of a test person for sensorial assessment of the flavouring substance(s).

A seventh subject matter according to the invention concerns a use of the device according to the invention for the production of a liquid flavouring substance condensate containing or consisting of one or more flavouring substances, water and ethanol, wherein the ethanol content is ≦15% by weight with reference to the total weight of the condensate.

The proportions as a percentage by weight (% by weight) with regard to the subject matters according to the invention are in each case with reference to the total weight of the liquid preparation.

The subject matters according to the invention likewise include in every conceivable combination the preferred configurations, as represented in the following description, the figures, the embodiments and the dependent claims.

### DESCRIPTION OF FIGURES

The figures show both a schematic layout of a device (1) according to the invention and a device (1) according to the invention in combination with systems connected up-and downstream.

The figures show as follows:

FIG. 1: a schematic layout of a device (1) according to the invention.

FIG. 2: a schematic layout of a device (1) according to the invention coupled with a liquid chromatography system (6).

FIG. 3: a schematic layout of a device (1) according to the invention coupled to a sample vessel (61) containing a flavouring substance sample.

### KEY

(1) Device according to the invention
(2) First nebuliser
(21) Liquid inlet of the first nebuliser
(22) Gas inlet of the first nebuliser
(2′) Second nebuliser
(21′) Liquid inlet of the second nebuliser
(22′) Gas inlet of the second nebuliser
(3) Mixing chamber
(31) Evaporator
(32) Inner wall of the mixing chamber
(33) Outer wall of the mixing chamber
(34) Inlet for a medium for temperature regulation
(35) Outlet for a medium for temperature regulation
(4) Separation chamber
(41) Gas outlet
(411) End of the gas outlet in the lower area inside the separation chamber
(412) End of the gas outlet in the area outside the separation chamber/device
(42) Eddy device
(43) Wall of the separation chamber
(5) Condensation chamber
(51) Liquid outlet
(52) Condenser
(53) Inner wall of the mixing chamber
(54) Outer wall of the mixing chamber
(55) Inlet for a medium for temperature regulation
(56) Outlet for a medium for temperature regulation
(6) Liquid chromatography system
(61) Sample vessel with flavouring substance sample
(62) Pump
(7) Inert gas container
(8) Detector

### DETAILED DESCRIPTION OF THE INVENTION

The present invention is based on the knowledge that with the device according to the invention a liquid flavouring substance condensate containing or consisting of one or more flavouring substances, one or more reference substances and water can be produced in a simple and rapid fashion thereby allowing (i) an on-line or synchronous sensorial assessment regarding synergic and/or masking characteristics by a test person (in vivo). The flavour concentrate that can be produced according to the invention according to the fifth to seventh subject matters according to the invention also has in an in vivo sensorial assessment a low risk of a misjudgement of the sensorial characteristics of the flavouring substance(s), since because of the ethanol content of ≦15% by weight with reference to the total weight of flavouring substance condensate the taste receptors are not (significantly) adversely affected and this also allows a test person not to have their awareness occasionally adversely affected in the event of more than 2 samples per day.

In the sense of the present invention, the term “flavouring substance” means a sensorially active substance, which causes a taste impression, i.e. conveys this itself or changes, i.e. modifies or intensifies, the taste perception of another substance on the basis of its inherent taste, wherein the substance has a vapour pressure of <0.05 Pa at 25° C.

In the sense of the present invention the term “flavouring substance preparation” means a liquid preparation containing or consisting of one or more flavouring substances, water and/or ethanol. The flavouring substance preparation according to the invention preferably has an ethanol content of >15% by weight, more preferably >20 % by weight with reference to the total weight of the flavouring substance preparation. Normally, the flavouring substance proportion is ≦5% by weight, preferably ≦2.5% by weight, more preferably ≦1% by weight and at least 10⁻¹²% by weight and the proportion of the water-ethanol-mixture is normally greater than or equal to 95% by weight, preferably greater than or equal to 97.5% by weight, more preferably greater than or equal to 99% by weight in each case with reference to the total weight of the flavouring substance preparation. The ethanol content in the water-ethanol-mixture is preferably in the range from 16 to 95% by weight, more preferably in the range from 25 to 90% by weight, particularly preferably in the range from 40 to 85% by weight, and quite particularly preferably in the range from 50 to 80% by weight, in each case with reference to the total weight of the water-ethanol-mixture. The higher the proportion of ethanol in the water-ethanol-mixture of the flavouring substance preparation, the less finely does the flavouring substance preparation, at the same temperature, have to be nebulised, in order to obtain a reduction according to the invention of the ethanol content.

The water- and/or ethanol proportion of the flavouring substance preparation according to the invention can also contain or consist of one ore more components, which are selected from the group comprising propylene glycol, glycerine, triacetine (glycerine triacetate), physiologically tolerated salts (for example sodium chloride), physiologically tolerated acids (for example phosphoric acid, acetic acid), physiologically tolerated buffer substances (for example sodium phosphate, sodium acetate), oils and fats, wherein the concentration of the component(s) in the water-ethanol-mixture is expediently selected in each case so that the flavouring substance preparation according to the invention remains completely harmless to health.

Where the water- and/or ethanol proportion of the flavouring substance preparation according to the invention contains physiologically tolerated salts (for example sodium chloride), physiologically tolerated acids (for example phosphoric acid, acetic acid) and/or physiologically tolerated buffer substances (for example sodium phosphate, sodium acetate), the total proportion of these salts, acids and/or buffer substances is preferably ≦10% by weight, preferably ≦5% by weight, particularly preferably in the range from 0.001 and 2% by weight, in each case with reference to the total weight of the flavouring substance preparation.

In the sense of the present invention the term “reference substance” means a sensorially active substance, which is purposefully used in a method according to the invention, in order to create a taste impression from the group consisting of umami, salty, sour, sweet, bitter, or prickling, cooling, burning, pungent or electrifying (tingling), so that a sensorial assessment of synergic or masking characteristics of the flavouring substance to be tested can be carried out from the flavouring substance preparation. The reference substances to be used according to the invention are preferably selected from the group consisting of:

| | |
|---|---|
| umami | sodium glutamate, inosine 5′-monophosphate, cyclopropyl |
| | carboxylic acid-N-neomenthylamide, n-ethyl-2-isopropyl-5- |
| | methylbicyco[4.1.0]heptan-7-carboxylic acid amide, |
| | n-cyclopentyl-2-isopropyl-5-methylbicyco[4.1.0]heptan- |
| | 7-carboxylic acid amide, preferably sodium glutamate |
| salty | sodium chloride, lithium chloride, potassium chloride, preferably |
| | sodium chloride |
| acid | citric acid, lactic acid, acetic acid |
| sweet | glucose, fructose, sucrose, sorbitol, mannitol, erythritol, |
| | tagatose, aspartame, saccharin and salts thereof, sucralose, |
| | Neotame, neohesperidin dihydrochalcone, acesulfame potassium, |
| | cyclamate, sodium cyclamate, thaumatin, stevioside, |
| | rebaudioside, preferably glucose or sucrose |
| bitter | caffeine, theobromine, amarogentin, quinine and salts thereof, |
| | humulone, iso-alpha-acids, catechins, in particular tea catechins, |
| | bitter peptides such as, for example, L-Leu-L-Trp-OH, |
| | potassium salts, magnesium sulphate, salicin, preferably |
| | caffeine or quinine |
| tingling | spilanthol, pellitorin, trans-pellitorin, sanshool and hydroxy- |
| | sanshool |
| cooling | menthol, l-menthol; icilin; menthane carboxylic acid amide, |
| | preferably L-menthane carboxylic acid-N-ethylamide (WS-3), |
| | N^{α}-(L-menthane carbonyl)-glycine ethyl ester (WS-5), |
| | 2,3-dimethyl-2-(2-propyl)-butyric acid-N-methyl amide |
| | (WS-23); menthyl acetate; L-menthyl lactate; L-menthyl |
| | ethylene glycol carbonate; L-menthyl propylene glycol |
| | carbonate; menthyl acetoacetate; menthyl-3-hydroxybutyrateM; |
| | menthone glycerine ketal; and isopulegol |
| burning | capsaicin; dihydrocapsaicin; piperine; gingerol, preferably [6]- |
| | gingerol; paradole, preferably [6]-paradole; shogaol; rubemamin; |
| | nonivamid; vanillmandelic acid alkyl amide (in particular the |
| | heptyl-, octyl-, nonylamides), drimane, for example Polygodial |
| pungent | isothiocyanates, preferably phenyl ethyl isothiocyanate, allyl |
| | isothiocyanate, isobutly- or isopropyl isothiocyanate |

In the sense of the invention the term “reference preparation” means a liquid preparation containing or consisting of (a) one or more reference substances to be used according to the invention and (b) water and/or ethanol.

In the sense of the present invention the “flavouring substance condensate” is produced from the flavouring substance preparation according to the invention and contains or consists of one or more flavouring substances, one or more reference substances, water and ethanol. In a preferred configuration the flavouring substance condensate according to the invention has an ethanol content of ≦15% by weight, more preferably in the range from 0 to 10% by weight, particularly preferred in the range from 0.1 to 8% by weight, and quite particularly preferred in the range from 1 to 5% by weight, in each case with reference to the total weight of the flavouring substance condensate. Accordingly, in the preferred configuration the flavouring substance concentrate according to the invention compared with the flavouring substance preparation according to the invention has a lower presence in terms of the ethanol content, so that the danger of misjudgements regarding the taste or of occasional adverse effects on the awareness of a test person, which may result due to an ethanol content of more that 15% by weight, is minimised. Furthermore, the further components of the flavouring substance preparation can likewise be present in the flavouring substance concentrate according to the invention.

In the sense of the present invention the term “inert gas” means that the inert gas fed in does not alter the “liquid preparation”, in particular the “flavouring substance preparation” according to the invention from the chemical point of view. Inert gases are preferably selected from the group comprising: nitrogen, helium or argon. Particular preference is for nitrogen to be used as the inert gas according to the invention.

In the sense of the present invention the term “sensorial assessment” means that a sample, normally ≦5 ml, of a flavouring substance condensate produced according to the invention, is taken in the mouth of a test person and possibly swallowed, wherein the sample is gustatorily and/or retronasally assessed for sensorial impressions, for example umami, salty, sour, sweet, bitter, or prickling, cooling, burning, pungent or tingling effects. Amplifying or masking characteristics of the flavouring substances under test are in particular assessed in comparison with the reference substances used.

In the sense of the present invention a “liquid chromatography system (6)” to be used according to the invention is a device suitable for performing liquid chromatography (LC), preferably high pressure liquid chromatography (HPLC) and particularly high temperature liquid chromatography (HTLC) of a flavouring substance preparation with detection of the flavouring substance(s).

Suitable separation techniques for the liquid chromatography system (6) to be used according to the invention include: Reversed-Phase Chromatography (RP), Normal Phase Chromatography (NP), Size Exclusion Chromatography (SEC) and Hydrophilic Interaction Chromatography (HILIC).

Normally the detectors are selected from the group consisting of mass selective detectors (MS), ultraviolet detectors (UV), diode array detectors (DAD), refraction index detectors (RI), evaporative light scattering detectors (ELSD), fluorescence detectors (FLD) or charged aerosol detectors (CAD).

Preferably a high pressure liquid chromatography system (6) contains or consists of a degasser (for example 3315, from ERC), two pumps (for example Sun Flow 100, from Sunchrom), a mixer (for example dynamic/static mixer, from Sunchrom), an auto-sampler (for example Midas, from Spark), a chromatography column (for example a Hamilton PRP-1 250×10 mm column) and a detector (preferably a diode array detector, for example Spectra Flow 600, from Sunchrom). In a high temperature liquid chromatography system to be used according to the invention the chromatography column is usually arranged in a column oven suitable for setting the necessary temperature in the column (for example Polaratherm, from Selerity).

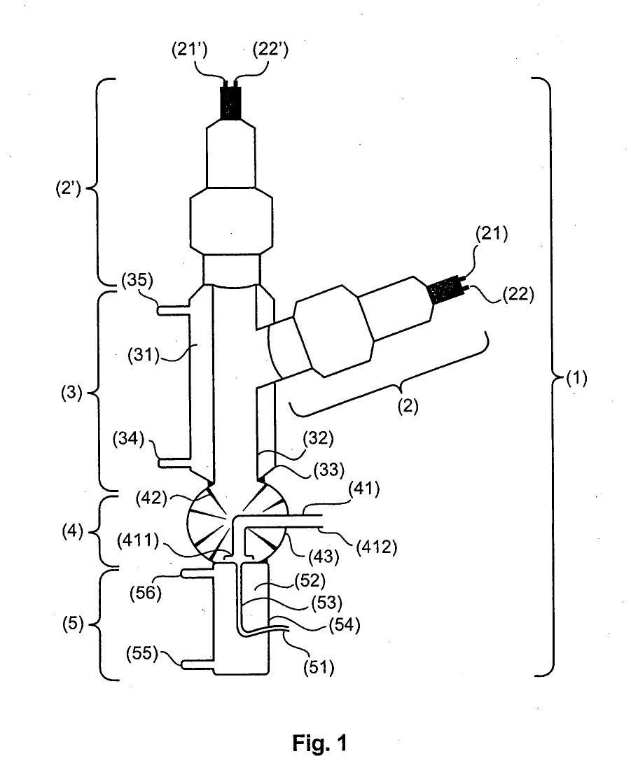

FIG. 1 is a schematic layout (on a scale of 1:2, i.e. the device is twice the size shown in the illustration in FIG. 1) of a device (1) according to the invention, which is suitable for the sensorial assessment of a flavouring substance preparation according to the invention.

The liquid flavouring substance preparation is fed through the liquid inlet (21) into the first nebuliser (2). Additionally an inert gas is fed through the gas inlet (22) (essentially) simultaneously with the introduction of the liquid into the nebuliser (2). By means of the nebuliser (2) the liquid fed in and the inert gas fed in are nebulised into an aerosol and fed into the mixing chamber (3) as an aerosol.

The liquid reference preparation is fed through the liquid inlet (21′) into the second nebuliser (2′). Additionally an inert gas is fed through the gas inlet (22′) (essentially) simultaneously with the introduction of the liquid into the nebuliser (2′). By means of the nebuliser (2′) the liquid fed in and the inert gas fed in are nebulised into an aerosol and in fed into the mixing chamber (3) as an aerosol.

The liquid reference preparation can be continuously fed into the second nebuliser (2′), so that the reference substance is contained within the flavouring substance condensate for the whole time. In the event that the flavouring substance preparation is an LC eluate and the eluate does not contain the flavouring substance under test, the reference substance in the condensate can then simultaneously serve as the reference value for the sensorial impression of the reference substance.

In an alternative configuration the feed of the reference preparation and/or the gas feed to the second nebuliser (2′) can be stopped by means of controls. The gas feed to the second nebuliser (2′) is preferably open. This configuration allows a sensorial assessment regarding the sensorial contribution of the flavouring substance(s) under test.

In a preferred configuration the first and/or second nebuliser (2,2′) is operated at a temperature of ≦100° C., preferably ≦75° C., more preferably in a range of between 10 and 40° C., particularly preferred in a range of between 15 and 30° C. and quite particularly preferred in a range of from 20 to 25° C. These temperature ranges minimise the risk of boiling delay. Furthermore, by adjusting the temperature it is possible to control the droplet size of the aerosol. For droplets of the aerosol with an average smaller diameter the surface area of the liquid in the aerosol is greater than for droplets with an average larger diameter. The greater the surface area of the droplets in the aerosol, the higher will be the proportion of the evaporation of the ethanol or the ethanol-water-mixture in the aerosol in the subsequent evaporation step.

The flavouring substance preparation and reference preparation fed in and the inert gas fed in are fed in at the normal flow rate or normal pressure into the first and second nebulisers (2,2′), so that on the one hand nebulisation into an aerosol is allowed and on the other the aerosol formed can be transported by the device (1) according to the invention. Flow rates and pressures can depend on the design of the first and second nebulisers (2′) and vary accordingly.

Nebulisers (2,2′) to be used according to the invention are preferably nebulisers for evaporative light scattering detectors (ELSD), which for example are described in U.S. Pat. No. 7,290,723, U.S. Pat. No. 6,528018, U.S. Pat. No. 6,485,689, U.S. Pat. No. 6,362,880, U.S. Pat. No. 6,229,605, U.S. Pat. No. 6,151,113 and U.S. Pat. No. 6,122,055, wherein the designs for the respective nebulisers from the abovementioned documents are included in the present description, as well as thermospray nebulisers which, for example, are described in DE 3 941 533 A1, U.S. Pat. No. 4,730,111 and U.S. Pat. No. 4,629,478, wherein the designs for the thermospray nebulisers taken from the respective abovementioned documents are included in the present description. Particular preference is for nebulisers for evaporative light scattering detectors, for example the nebulisers from Sedere for a flow range of 1-5 ml/min.

The preferred nebuliser (2,2′) from Sedere usually includes a gas inlet (22) with controller for setting the working pressure within the nebuliser (2) in the range 0.5 to 5 bar, preferably in the range from 1 to 4 bar, more preferably 2 to 3 bar and quite particularly preferably at 3 bar.

Additionally or alternatively, the liquid inlet (21) of the nebuliser (2,2′) from Sedere normally includes a controller for adjusting the flow rate of the liquid in the nebuliser (2) in the range from 1 to 5 ml/min, preferably, 2 to 4 ml/min, particularly preferably at 3 ml/min.

The preferred flow rates and working pressures outlined above allow a particularly preferred nebulisation into an aerosol and a preferred subsequent onward transport of the aerosol formed through the device (1) according to the invention.

In a further preferred configuration the device (1) according to the invention in addition or alternatively to the abovementioned preferred configurations is arranged vertically to the centre of the earth so that the first and/or second nebuliser (2,2′), preferably the second nebuliser (2′) is arranged at the top end, i.e. at the end furthest away from the centre of the earth, of the device (1) according to the invention, and the condensation chamber (5) at the bottom end, i.e. at the end closest to the centre of the earth, of the device (1) according to the invention. Such a construction is advantageous since gravity makes an additional contribution to the prevailing working pressure for the further transport of the aerosol through the device (1) according to the invention and as a result the flow rate and/or the working pressure can be reduced.

In a further preferred configuration according to the invention the second nebuliser (2′), into which the reference preparation is fed, is connected at the top end of the device with the mixing chamber (3) and the first nebuliser (2), into which the flavouring substance preparation is fed, is connected below the second nebuliser (2′) with the mixing chamber (3). By virtue of a corresponding construction with the method according to the invention for producing a liquid flavouring substance condensate suitable for the sensorial assessment of the amplifying or reducing flavouring substance characteristics by a test person, a better mixing of the aerosol of the flavouring substance preparation with the aerosol of the reference preparation can be observed. It is assumed that for the method according to the invention for sensorial assessment on the basis of the preferred configuration of the device according to the invention described above the quality of the sensorial assessment will also be improved.

In a further preferred configuration the device (1) according to the invention in addition or alternatively to the abovementioned preferred configurations is also characterised in that the evaporator (31) is arranged as the temperature controller in the range from 30 to 100° C., preferably 50 to 95° C., more preferably 70 to 90° C., particularly preferably 75 to 85° C. and quite particularly at 80° C. The temperature is preferably set so that a sufficient quantity of ethanol is converted to the gas phase, so that the ethanol proportion removed from the device (1) in the separation chamber (4) is sufficient so that the condensate removed from the condensation chamber (5) by means of the liquid outlet (51 ) has an ethanol content of ≦15% by weight, preferably in the range of 0 to 10% by weight, further preferred in the range from 0.1 to 8% by weight, particularly preferred in the range from 1 to 5% by weight, in each case with reference to the total weight of the condensate. Preferably, therefore, the ethanol content, which passes into the mixing chamber (3) in the gas phase, is ≧50% by weight, further preferred in the range from 60 to 100% by weight, particularly preferred in the range from 70 to 95% by weight, in each case with reference to the total weight of the flavouring substance preparation fed in.

In a further preferred configuration the device (1) according to the invention in addition or alternatively to the abovementioned preferred configurations is characterised in that the mixing chamber (3) is in the form of a tube, i.e. with an (essentially) circular cross-section of normally 50 mm, preferably 35 mm and particularly preferably 25 mm and with a length of normally 150 mm, preferably 120 mm and particularly preferably 90 mm. Out of particular preference this tube has an even cross-section and/or is not bent. This preferred configuration is advantageous since due to the tubular shape the dead volume is minimised thereby leading to low turbulence flow.

In a further preferred configuration the device (1) according to the invention in addition or alternatively to the abovementioned preferred configurations is characterised in that mixing chamber (3) is in the form of a double-walled tube, which around its first inner wall (32) and with a clearance from the latter has a second outer wall (33) with an inlet (34) and an outlet (35) for a medium for temperature regulation. In this preferred configuration the evaporator (31) consists of the double walled tube configuration (heating jacket), in which the medium for temperature regulation, normally a liquid selected from the group comprising water or mineral oil as a thermal transfer medium and water, ethylene glycol or mixtures of water and ethylene glycol as a cold transfer medium, is heated to the desired temperature and fed through the inlet (34) into the area between the first inner wall (32) and with a clearance from the latter the second outer wall (33) and is removed from the outlet (35) as necessary. This preferred configuration means that the mixing chamber (3) can be kept at an (essentially) constant temperature, since new media at the correct temperature is constantly fed into the heating jacket for temperature control or medium that has already been used for temperature control once it leaves the outlet (35) can be reheated to the starting temperature.

In an alternative configuration an evaporator to be used according to the invention can have a thermoelectric plate (Peltier element), an electric heater band, an electric heating jacket or an electric heater tube.

In a further preferred configuration the device (1) according to the invention in addition or alternatively to the abovementioned preferred configurations is characterised in that the separation chamber (4) has an at least equally sized or larger cross-section, i.e. an (essentially) circular cross-section, compared to the mixing chamber (3), wherein the cross-section of the separation chamber (4) is normally in the range of 100 mm, preferably 70 mm, particularly preferably 50 mm and the length of the separation chamber (4) is normally in the range of 150 mm, preferably in the range of 100 mm and particularly preferably 65 mm. In a quite particularly preferred configuration according to the invention the separation chamber (4) is in the form of a sphere. A change in the cross-section normally leads to a diffusion of the evaporated aerosol, so that flow turbulence results and swirling in the separation chamber (4) is supported. As a result of this the separation of the gaseous proportion and of the liquid aerosol proportion is likewise supported, allowing improved removal of the gaseous ethanol proportion through the gas outlet (41) from the separation chamber and thus from the device (1) according to the invention. In a further preferred configuration the swirling of the aerosol in the separation chamber (4) is further supported by one or more eddy devices (42), preferably rod or mandrel-like devices, which are connected with the separation chamber wall (43) and extend into the inside of the separation chamber (4).

In a further preferred configuration the device (1) according to the invention in addition or alternatively to the abovementioned preferred configurations is characterised in that the gas outlet (41) is in the form of a tube, i.e. with an (essentially) circular cross-section, which runs through an outer wall (43) of the separation chamber (4) into an area outside of the device (1), wherein one end of the tube (411) is arranged inside the separation chamber (4) in an area which is opposite the connection to the mixing chamber (3), and a second end of the tube (412) in the area outside of the device (1). In a further preferred configuration the device (1) according to the invention in addition or alternatively to the abovementioned preferred configurations is characterised in that the gas outlet (41) in the constructed state is arranged at the bottom end of the separation chamber (5) and in an area above the bottom end runs through the outer wall (43) of the separation chamber (4) into the area outside of the device (1).

It is preferable for the gas outlet (41) to be arranged at the bottom end of the separation chamber (4), i.e. in the vicinity of the condensation chamber (5), since as a result of the drop in temperature the liquid droplets of the aerosol to a large extent condense and can then be discharged via the liquid outlet (51) as condensate, while the to a large extent separated gas proportion of the aerosol can be removed via the gas outlet (41) from the device (1).

The gas outlet (41) is preferably a glass tube, with a cross-section of between 5 and 15 mm, more preferably approximately 10 mm and is normally arranged less than 10 mm, preferably less than 5 mm, and quite particularly preferably approximately 3 mm above the transition to the condensation chamber (5). In a further preferred configuration the end of the tube (411) is in the shape of a funnel. Through the funnel-shaped design of the opening (411) turbulence in the condensation zone is avoided, so that the condensate can trickle evenly from the liquid outlet (51).

In a preferred configuration the gas outlet is not arranged linearly but angularly, preferably at an angle of 90°. Here, normally the lengths of the gas outlet tube (41) vertically (vertical tube) and horizontally (cross tube) to the centre of the earth are approximately the same, with the vertical tube preferably being approximately 27 mm long and having a clearance of 3 mm from the condensation chamber (5) and the cross tube preferably being 30 mm long.

In a further preferred configuration the device (1) according to the invention in addition or alternatively to the abovementioned preferred configurations is characterised in that the separation chamber (4) is operated at ambient temperature and is not cooled according to the condensation chamber (5). This configuration is therefore preferred because through the coupling of the heated mixing chamber (3) and the cooled condensation chamber (5) via the separation chamber (4) to be used according to the invention a “temperature buffer” is interposed, which reduces the material damage to the device (1) as a result of the drop in temperature.

In a further preferred configuration the device (1) according to the invention in addition or alternatively to the abovementioned preferred configurations is characterised in that the condensation chamber (5) has a tube, i.e. it has an (essentially) circular cross-section. As already explained above concerning the mixing chamber (3) a tube has a low dead volume.

In a further preferred configuration the device (1) according to the invention in addition or alternatively to the abovementioned preferred configurations is characterised in that the tube of the condensation chamber (5) has a smaller cross-section compared to the separation chamber (4) and/or the mixing chamber (3), i.e. normally a cross-section in the range of 8 mm, preferably 5 mm and particularly preferably 2 mm and a length of normally 80 mm, preferably 50 mm and particularly preferably 35 mm. This reduction in cross-section leads to a contraction of the aerosol contained in the separation chamber (4) and passed in to the condensation chamber (5), so that the effect of the condenser (52) is supported.

In a further preferred configuration the device (1) according to the invention in addition or alternatively to the abovementioned preferred configurations is characterised in that the condenser (52) is designed as a temperature controller in the range from 0 to 60° C., preferably from 5 to 50° C., more preferably from 10 to 40° C., particularly preferably from 15 to 25° C. and quite particularly at 20° C. Because of these temperature ranges the condensation of the aerosol into the flavouring substance condensate according to the invention is supported.

In a further preferred configuration the device (1) according to the invention in addition or alternatively to the abovementioned preferred configurations is characterised in that the condensation chamber (5) is in the form of a double-walled tube, which around its inner wall (53) and with a clearance from the latter has a second outer wall (54) with an inlet (55) and an outlet (56) for a medium for temperature control, normally a liquid, preferably a liquid selected from the group comprising water or mineral oil as a heat transfer medium and water, ethylene glycol or mixtures of water and ethylene glycol as a cold transfer medium. As already explained above concerning the mixing chamber (3) according to the invention, this preferred configuration means that the condensation chamber (5) is (essentially) kept constantly at the correct temperature.

In an alternative configuration a condenser (52) to be used according to the invention can be a thermoelectric plate (Peltier element), an electric temperature maintenance band, an electric temperature maintenance jacket or an electric temperature maintenance tube.

In a further preferred configuration the device (1) according to the invention in addition or alternatively to the abovementioned preferred configurations is characterised in that the liquid outlet (51) is arranged at the bottom end of the condensation chamber (5). This preferred configuration means that the condensate formed can be removed by means of gravity via the liquid outlet (51) from the condensation chamber (5) and thus from the device (1) according to the invention. Additionally, however, other means, in particular pumps (for example suitable peristaltic pumps or LC pumps—not shown) could be connected downstream of the condensation chamber (5), in order to remove the condensate from the device (1).

The device (1) according to the invention can be manufactured from any suitable material, preferably from one or more materials selected from the group comprising glass, metal, precious metal, steel or plastic (e.g. polytetrafluorethylene or polyetheretherketone), particularly preferably glass, wherein the individual chambers and devices are connected with one another in such a way that from the device (1) according to the invention, other than from the outlet points provided, in particular the gas outlet (41) and the liquid outlet (51), (essentially) neither the inert gas fed in nor (also) the liquid preparation fed in, preferably the liquid flavouring substance preparation, escapes from the device (1) according to the invention. In a particularly preferable configuration the device (1) according to the invention in addition or alternatively to the abovementioned particularly preferred configurations is constructed partially or completely from heat-resistant glass.

In a further preferred configuration in addition or alternatively to the abovementioned preferred configurations the condensate removed from the device (1) according to the invention can be separated into two, three or more eluate fractions, wherein the fractions are particularly preferably separated in such a way that a fraction essentially contains a flavouring substance and a reference substance. For the determination of a flavouring substance concentrate fraction, containing a flavouring substance and a reference substance, one or more, identical or different suitable detectors (not shown) can be used, preferably selected from the group consisting of mass selective detectors (MS), ultraviolet detectors (UV), diode array detectors (DAD), refraction index detectors (RI), evaporative light scattering detectors (ELSD), fluorescence detectors (FLD) or charged aerosol detectors (CAD), arranged in front of or after the device (1) according to the invention. This preferred configuration allows sensorial assessment of the amplifying or masking characteristics of the isolated flavouring substance compared with the sensorial impression of the reference substance alone.

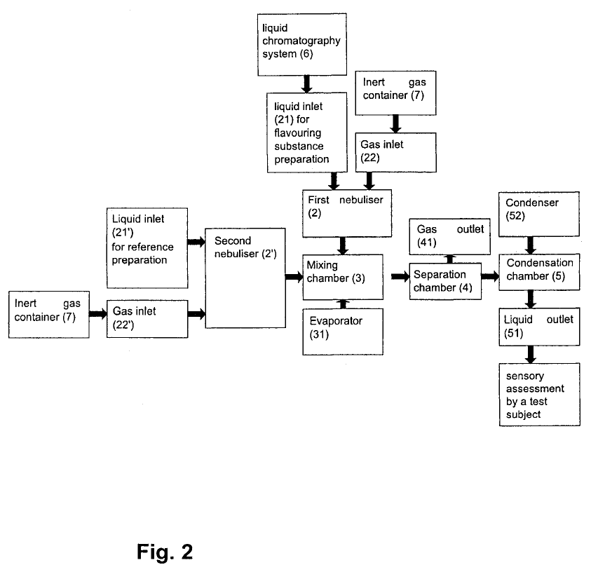

FIG. 2 is a schematic layout of a device (1) according to the invention which likewise contains the preferred configurations explained above in all conceivable combinations, coupled to a liquid chromatography system (6) to be used according to the invention (6).

The preferred configuration of the device (1) according to the invention can be connected in a preferred configuration with the liquid chromatography systems (6) which can be used according to the invention with various separation methods directly, i.e. via the liquid inlet (21), so that the eluate can be fed via the liquid inlet (21) into the first nebuliser (2).

The coupling of the device (1) according to the invention is therefore preferred firstly because through the liquid chromatographic separation of a liquid flavouring substance sample, containing two, three or more flavouring substances, a temporal separation of the flavouring substances is already brought about by the eluate of water and ethanol used, possibly in gradient operation, wherein the eluate from a liquid chromatographic separation corresponds to the flavouring substance preparation according to the invention. Secondly, the liquid chromatography system (6) to be used according to the invention already has a detector that is positioned accordingly upstream of the device (1) according to the invention, allowing a better estimation of when the flavouring substance(s) after passing through the device (1) according to the invention can be expected in the flavouring substance condensate produced.

In an alternative preferred configuration the device (1) according to the invention is coupled indirectly with an abovementioned liquid chromatography system (6) that can be used in the normal way, i.e. one or more of the eluate fractions that have been separated by means of this liquid chromatography system (6) to be used according to invention, which preferably each contain just one flavouring substance, are fed with the device (1) according to the invention one after another via the liquid inlet (21) into the first nebuliser (2).

Through the compact design of the device (1) according to the invention and through the additional feeding of the reference preparation and/or of the inert gas into the second nebuliser (2′) the flow rate of an LC eluate as a liquid flavouring substance preparation or the flow rate of the aerosol, i.e. the time taken for transport through the device (1) according to the invention, are set such that the liquid chromatographic separation capability is guaranteed and so an on-line or synchronous sensorial assessment regarding the taste of a single flavouring substance and thus of the sensorial contribution of the flavouring substance by a test person is made possible. Normally at a pressure of 3 bar at the nebuliser (2) the aerosol/gas speed is −65 ml/s. The passage time of the aerosol varies according to the temperatures (evaporation/condensation) in the device (1), between fractions of a second and 1, 2 or a few seconds.

Thus, according to a further preferred configuration in addition or alternatively to the abovementioned preferred configurations the method according to the invention for producing a liquid flavouring substance condensate suitable for sensorial assessment of amplifying or reducing flavouring substance characteristics by a test person can be characterised in that the flavouring substance preparation, which in step a) is fed into the nebuliser (2), is an eluate obtained by means of a liquid chromatography system (6) to be used according to the invention.

In a further preferred configuration in addition or alternatively to the abovementioned preferred configurations the method according to the invention for producing a liquid flavouring substance condensate suitable for sensorial assessment of amplifying or reducing flavouring substance characteristics by a test person can be characterised in that the liquid chromatography system (6) with the liquid inlet (21) is connected to the first nebuliser (2) in such a way that the eluate as the flavouring substance preparation immediately after separation by means of the liquid chromatography system, (6) is fed via the liquid inlet (21) into the nebuliser (2).

In a further preferred configuration in addition or alternatively to the abovementioned preferred configurations the method according to the invention for producing a liquid flavouring substance condensate suitable for sensorial assessment of amplifying or reducing flavouring substance characteristics by a test person, can be characterised in that the eluate from the liquid chromatography system (6) by means of a detector (8), arranged between the liquid chromatography system (6) and the first nebuliser (2), is investigated for the presence of a flavouring substance in the eluate.

In a further preferred configuration, in addition or alternatively to the abovementioned preferred configurations, the method according to the invention for production of a liquid flavouring substance condensate suitable for sensorial assessment of amplifying or reducing flavouring substance characteristics by a test person can be characterised in that the reference preparation and the inert gas in step d) are fed, over at least a period within which by means of the detector (8) a flavouring substance was detected in the eluate, to the second nebuliser (2′).

In a further preferred configuration in addition or alternatively to the abovementioned preferred configurations the method according to the invention for producing a liquid flavouring substance condensate suitable for sensorial assessment of amplifying or reducing flavouring substance characteristics by a test person can be characterised in that, in step c) a flavouring substance preparation with an ethanol content of >15% by weight with reference to the total weight of the flavouring substance preparation is fed into the first nebuliser (2) and in step f) enough gaseous ethanol is removed from the separation chamber (4), that the liquid flavouring substance condensate removed in step h) has an ethanol content of ≦15% by weight with reference to the total weight of the flavouring substance condensate.

In a further preferred configuration in addition or alternatively to the abovementioned preferred configurations the method according to the invention for producing a liquid flavouring substance condensate suitable for sensorial assessment of amplifying or reducing flavouring substance characteristics by a test person is characterised in that in step c) a flavouring substance preparation with an ethanol content of >15% by weight with reference to the total weight of the flavouring substance preparation is fed into the first nebuliser (2) and in step d) a reference preparation without ethanol or with a sufficiently low ethanol content is fed into the second nebuliser (2′), so that the liquid flavouring substance condensate removed in step h) has an ethanol content of ≦15% by weight with reference to the total weight of the flavouring substance condensate.

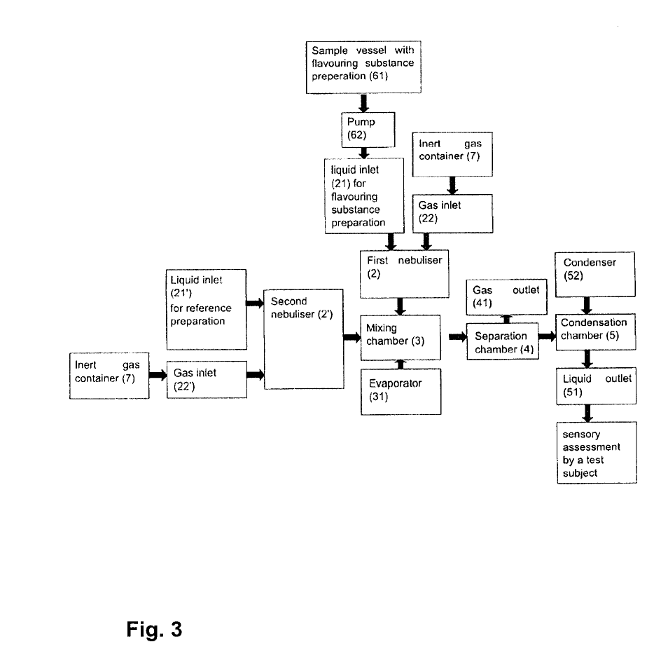

FIG. 3 is a schematic layout of a device (1) according to the invention, which likewise includes the preferred configurations described above in all conceivable combinations, coupled to a sample vessel (61) containing a flavouring substance preparation according to the invention with preferably one flavouring substance, which are connected together in such a way that this flavouring substance preparation if necessary by means of a suitable normal pump (62), for example an LC pump or peristaltic pump, is fed through the liquid inlet (21) into the first nebuliser (2). Between the sample vessel (61) and the liquid inlet (21) a detector (8) can preferably be interposed, in order to allow a better estimation of when the flavouring substance(s) passes/pass through the device (1) according to the invention.

Normally, the detectors are selected from the group comprising mass selective detectors (MS), ultraviolet detectors (UV), diode array detectors (DAD), refraction index detectors (RI), evaporative light scattering detectors (ELSD), fluorescence detectors (FLD) or charged aerosol detectors (CAD).

### Embodiment

The present invention is described in the following through an embodiment, but without this limiting the scope of protection of the subject matters according to the invention.

### EXAMPLE 1

### Identification of Bitter Masking Substances from Herba Santa (Eriodictyon californicum)

1. Preparation of a Sample Solution

A sample solution of Herba Santa is prepared by dissolution/suspension of 500 mg Herba Santa in a mixture of water/ethanol (1:1/v:v), with subsequent membrane filtration of the undissolved residue.

2. Liquid Chromatography of the Sample Solution

The HTLC device used, consisting of a degasser (3315, from ERC), two pumps (Sun Flow 100, from Sunchrom), a mixer (dynamic/static mixer, from Sunchrom), an auto-sample (Midas, from Spark), a column oven (Polaratherm, from Selerity) and a diode array detector (Spectra Flow 600, from Sunchrom) is fitted with a Hamilton PRP-1 250×10 mm column and conditioned with a flow of 3 ml/min of an eluate consisting of 30% by weight of ethanol and 70% by weight of water.

To position the sample in the conditioned HTLC device used, with the autosampler 100 μl of the clear solution prepared was injected.

Once conditioning was complete the chromatographic analysis took place according to the following programme:

| | | | | | Column | | Diode |
|---|---|---|---|---|---|---|---|
| | | | | Elution | oven | Temperature | array |
| Time | Flow | Water | Ethanol | gradient | temperature | gradient | detector |
| [min] | [ml/min] | [%] | [%] | [%/min] | [° C.] | [° C./min] | (DAD) |
| 0 | 3 | 70 | 30 | 1.4 | 120 | Isothermal | 210 nm |
| 50 | 3 | 0 | 100 | Iso-cratic | 120 | Isothermal | 210 nm |
| 65 | 3 | 0 | 100 | Iso-cratic | 120 | Isothermal | 210 nm |

The changes in temperature, flow and eluate composition during the programme took place linearly. The compound homoeriodictyol present in the Eriodictyon californicum eluated following chromatographic separation at an ethanol concentration of 45%.

The eluate is then introduced to the chromatic separation under the following conditions via the liquid inlet (21) directly into the nebuliser (2) of the device (1) according to the invention:

| Gas | Gas | | | | |
|---|---|---|---|---|---|
| pressure | pressure | Flow in | Flow in | | |
| in the | in the | the liquid | the liquid | Evaporator | Condenser |
| gas inlet | gas inlet | inlet | inlet | (31) | (51) |
| (22) | (22′) | (21) | (21′) | temperature | temperature |
| 3 bar | 3 bar | 3 ml/min | 3 ml/min | 80° C. | 30° C. |

Via the liquid inlet (21) the 0.10% by weight caffeine solution (1,000 ppm) as the reference preparation and nitrogen as the inert gas are fed into the second nebuliser (2) introduced synchronously with the eluate as a flavouring substance preparation into the mixing chamber (3), in order to bring about the mixing of the flavouring substance to be assessed sensorially and the reference preparation (caffeine solution) and in order to allow a reduction in the ethanol content.

The flavouring substance condensate ultimately obtained at the liquid outlet (51) of the condensation chamber (5) has an ethanol content of approximately ˜6%.

The condensate obtained is directly assessed sensorially by a panel of trained test persons.

In order to obtain a blank test the above trial is carried out again as described above with pure water in place of the flavouring substance preparation. The condensate obtained in this way is tasted by comparison with the flavouring substance condensate previously obtained, in order to be able to determine the reduction in the bitterness due to the flavouring substance in the flavouring substance preparation.

### Specific Embodiments

Specific embodiment one comprises a device (1) for producing a liquid flavouring substance condensate that is suitable for sensorial assessment by a test person with two nebulisers (2, 2′), a mixing chamber (3), a separation chamber (4) and a condensation chamber (5), characterised in that
the first nebuliser (2) contains or consists of a liquid inlet (21), a gas inlet (22) and a connection to the mixing chamber (3), so that a liquid flavouring substance preparation containing one or more flavouring substances, water and/or ethanol by means of the liquid inlet (21) and an inert gas by means of the gas inlet (22) can be fed into the nebuliser (2) and the nebuliser (2) is suitable for nebulising the liquid and the inert gas into an aerosol and feeding them in this way into the mixing chamber (3),
the second nebuliser (2′) contains or consists of a liquid inlet (21′), a gas inlet (22′) and a connection to the mixing chamber (3), so that a liquid reference preparation containing one or more reference substances, water and/or ethanol by means of the liquid inlet (21′) and an inert gas by means of the gas inlet (22′) can be fed into the nebuliser (2′) and the nebuliser (2′) is suitable for nebulising the liquid and the inert gas into an aerosol and feeding them in this way into the mixing chamber (3),
the mixing chamber (3) contains or consists of a condenser (31) and a connection to a separation chamber (4), wherein the mixing chamber (3) is arranged after the first and second nebulisers (2, 2′) and is thus connected in such a way that the aerosols formed by the first and second nebulisers (2, 2′) can be fed into the mixing chamber (3) separately and the evaporator (31) is suitable for converting part or all of the ethanol in the aerosols fed in partially or completely into the gas phase,
the separation chamber (4) contains or consists of a gas outlet (41) and a connection to the condensation chamber (5), wherein the separation chamber (4) is arranged after the mixing chamber (3) and is connected in such a way that the ethanol converted to the gas phase and the remaining aerosol can be fed into the separation chamber (4) and part or all of the ethanol gas phase can be removed from the device (1) via the gas outlet (41) and
the condensation chamber (5) contains or consists of a liquid outlet (51) and a condenser (52), wherein the condensation chamber (5) is arranged after the separation chamber (4) and is connected in such a way that the aerosol remaining in the separation chamber (4) following the partial or complete removal of the ethanol gas phase can be fed into the condensation chamber (5) and the condenser (5) is suitable for condensing the aerosol fed in fully or in part and the condensate can be removed from the condensation chamber (5) via the liquid outlet (51).

Specific embodiment two comprises a device according to specific embodiment one, characterised in that the first and/or second nebuliser (2, 2′) is operated at a temperature of ≦75° C., preferably in a range of between 10 and 40° C., more preferably in a range of between 15 and 30° C. and quite particularly preferably in a range of from 20 to 25° C.

Specific embodiment three comprises the device according to specific embodiment one or two, characterised in that the gas inlet (22, 22′) of the first and/or second nebuliser (2, 2′) has a controller for adjusting a working pressure in the nebuliser (2, 2′) in the range from 0.5 to 5 bar, preferably in the range from 1 to 4 bar, more preferably from 2 to 3 bar and quite particularly preferably at 3 bar.

Specific embodiment four comprises the device according to any one of the preceding specific embodiments, characterised in that the liquid inlet (21, 21′) of the first and/or second nebuliser (2, 2′) has a controller for adjusting the feed rate of the liquid into the nebuliser (2, 2′) in the range from 1 to 5 ml/min, preferably, 2 to 4 ml/min, particularly preferably 3 ml/min.

Specific embodiment five comprises the device according to any one of the preceding specific embodiments, characterised in that a liquid chromatography system (6) is connected to the liquid inlet (21) of the first nebuliser (2), so that an eluate obtained by means of the liquid chromatography system (6) as the flavouring substance preparation can be fed through liquid inlet (21) of the nebuliser (2).

Specific embodiment six comprises a device according to specific embodiment five, characterised in that between the liquid chromatography system (6) and the first nebuliser (2) a detector (8) for detection of the flavouring substance(s) in the eluate is arranged.

Specific embodiment seven comprises a method for producing a liquid flavouring substance condensate suitable for sensorial assessment of amplifying or reducing flavouring substance characteristics by a test person containing or consisting of the following steps:
a) provision of a liquid flavouring substance preparation, containing or consisting of one or more flavouring substances, water and/or ethanol, and an inert gas,
b) provision of a liquid reference preparation, containing or consisting of one or more reference substances, water and/or ethanol, as well as an inert gas,
c) feeding of the liquid flavouring substance preparation from step a) through a liquid inlet (21) and the inert gas through a gas inlet (22) into a first nebuliser (2) by means of which the flavouring substance preparation and the inert gas are nebulised into an aerosol and in this way fed into a mixing chamber (3),
d) feeding of the liquid reference preparation from step b) through a liquid inlet (21′) and the inert gas through a gas inlet (22′) into a second nebuliser (2′) by means of which the reference preparation and the inert gas are nebulised into an aerosol and in this way fed into a mixing chamber (3),
e) conversion of part or all of the ethanol content of the aerosols fed into the mixing chamber (3) in step d) by means of an evaporator (31) into a gas phase,
f) passing of the aerosol formed in step e) into a separation chamber (4) connected to the mixing chamber (3) and with a gas outlet (41) and removal of part or all of the gaseous ethanol content from the separation chamber (4) through the gas outlet (41),
g) passing of the aerosol formed in step f) into a condensation chamber (5) connected to the separation chamber (4) and with a liquid outlet (51) and a condenser (52) and condensation of the aerosol by means of the condenser (52) into a flavouring substance condensate containing or consisting of the flavouring substance(s), the reference substance(s), water and/or ethanol and h) removal of the flavouring substance condensate formed in step g) from the condensation chamber (5) through the liquid outlet (51). Specific embodiment eight comprises the method according to specific embodiment seven, characterised in that the flavouring substance preparation, fed into the first nebuliser (2) in step a) is an eluate obtained by means of a liquid chromatography system (6).

Specific embodiment nine comprises the method according to specific embodiment seven or eight, characterised in that the eluate from the liquid chromatography system (6) is investigated by means of a detector (8), arranged between the liquid chromatography system (6) and the first nebuliser (2), for the presence of a flavouring substance in the eluate.

Specific embodiment ten comprises the method according to any one of specific embodiments seven to nine, characterised in that in step c) a flavouring substance preparation with an ethanol content of >15% by weight with reference to the total weight of the flavouring substance preparation is fed into the first nebuliser (2) and in step d) a reference preparation without ethanol or with a sufficiently low ethanol content is fed into the second nebuliser (2′), so that the liquid flavouring substance condensate removed in step h) has an ethanol content of ≦15% by weight with reference to the total weight of the flavouring substance condensate.

Specific embodiment eleven comprises a method for sensorial assessment of the amplifying and/or reducing taste impressions of one or more flavouring substances containing or consisting of the following steps:
i. production of a liquid flavouring substance condensate containing or consisting of one or more flavouring substances, one or more reference substances, water and/or ethanol according to the above method according to one of the methods according to specific embodiments seven to eleven and ii. introduction of the flavouring substance condensate from step i) into the mouth of a test person for sensorial assessment of amplifying and/or reducing taste impressions.

Specific embodiment twelve comprises use of a device according to any one of specific embodiments one to six for producing a liquid flavouring substance condensate containing or consisting of one or more flavouring substances, one or more reference substances, water and/or ethanol.

Specific embodiment thirteen comprises a method for diluting a liquid flavouring substance preparation containing or consisting of the following steps:
a) provision of a liquid flavouring substance preparation, containing or consisting of one or more flavouring substances, water and ethanol with an ethanol content of >15% by weight with reference to the total weight of the flavouring substance preparation, and an inert gas,
b) provision of a diluent, containing or consisting of water and/or ethanol, wherein the ethanol content is ≦15% by weight with reference to the total weight of the solution, and an inert gas,
c) feeding of the liquid flavouring substance preparation from step a) through a liquid inlet (21) and of the inert gas through a gas inlet (22) into a first nebuliser (2) by means of which the flavouring substance preparation and the inert gas are nebulised into an aerosol and in this way fed into a mixing chamber (3),
d) feeding of the diluent from step b) through a liquid inlet (21′) and of the inert gas through a gas inlet (22′) into a second nebuliser (2′) by means of which the diluent and the inert gas are nebulised into an aerosol and in this way fed into the mixing chamber (3),
e) conversion of part or all of the ethanol content of the aerosols fed into the mixing chamber (3) in step d) by means of an evaporator (31) into a gas phase,
f) passing of the aerosol formed in step e) into a separation chamber (4) connected with the mixing chamber (3) and with a gas outlet (41) and removal of part or all of the gaseous ethanol content from the separation chamber (4) through the gas outlet (41),
g) passing of the aerosol formed in step f) into a condensation chamber (5) connected with the separation chamber (4) and with a liquid outlet (51) and condenser (52) and condensation of the aerosol by means of the condenser (52) into a flavouring substance condensate containing or consisting of the flavouring substance(s), water and ethanol, wherein the ethanol content is ≦15% by weight with reference to the total weight of the condensate and
h) removal of the flavouring substance condensate formed in step g) from the condensation chamber (5) via the liquid outlet (51).

Specific embodiment fourteen comprises a method for sensorial assessment of one or more flavouring substances containing or consisting of the following steps:
i. production of a liquid flavouring substance condensate containing or consisting of one or more flavouring substances, water and ethanol according to specific embodiment thirteen, wherein the ethanol content is ≦15% by weight with reference to the total weight of the condensate, and
ii. introduction of the flavouring substance condensate from step i) into the mouth of a test person for sensorial assessment of the flavouring substance(s).

Specific embodiment fifteen comprises a use of a device according to any one of specific embodiments 1 to 6 for the production of a liquid flavouring substance condensate containing or consisting of one or more flavouring substances, water and ethanol, wherein the ethanol content is ≦15% by weight with reference to the total weight of the condensate.

We claim:

1. A device for producing a liquid flavouring substance condensate that is suitable for sensorial assessment by a test person, the device having a first and a second nebuliser, a mixing chamber, a separation chamber and a condensation chamber, wherein
the first nebuliser contains or consists of a liquid inlet, a gas inlet and a connection to the mixing chamber, so that a liquid flavouring substance preparation containing one or more flavouring substances, water and/or ethanol by means of the liquid inlet and an inert gas by means of the gas inlet can be fed into the first nebuliser and the first nebuliser is suitable for nebulising the liquid and the inert gas into an aerosol and feeding them in this way into the mixing chamber,
the second nebuliser contains or consists of a liquid inlet, a gas inlet and a connection to the mixing chamber, so that a liquid reference preparation containing one or more reference substances, water and/or ethanol by means of the liquid inlet and an inert gas by means of the gas inlet can be fed into the second nebuliser and the second nebuliser is suitable for nebulising the liquid and the inert gas into an aerosol and feeding them in this way into the mixing chamber,
the mixing chamber contains or consists of a condenser and a connection to a separation chamber, wherein the mixing chamber is arranged after the first and second nebulisers and is thus connected in such a way that the aerosols formed by the first and second nebulisers can be fed into the mixing chamber separately and the evaporator is suitable for converting part or all of the ethanol in the aerosols fed in partially or completely into the gas phase,
the separation chamber contains or consists of a gas outlet and a connection to the condensation chamber, wherein the separation chamber is arranged after the mixing chamber and is connected in such a way that the ethanol converted to the gas phase and the remaining aerosol can be fed into the separation chamber and part or all of the ethanol gas phase can be removed from the device via the gas outlet and
the condensation chamber contains or consists of a liquid outlet and a condenser, wherein the condensation chamber is arranged after the separation chamber and is connected in such a way that the aerosol remaining in the separation chamber following the partial or complete removal of the ethanol gas phase can be fed into the condensation chamber and the condenser is suitable for condensing the aerosol fed in fully or in part and the condensate can be removed from the condensation chamber via the liquid outlet.

2. The device according to claim 1, wherein the first and/or second nebuliser is operated at a temperature of ≦75° C.

3. The device according to claim 1, wherein the gas inlet of the first and/or second nebuliser has a controller for adjusting a working pressure in the nebuliser in the range from 0.5 to 5 bar.

4. The device according to claim 1, wherein the liquid inlet of the first and/or second nebuliser has a controller for adjusting the feed rate of the liquid into the nebuliser in the range from 1 to 5 ml/min.

5. The device according to claim 1, wherein a liquid chromatography system is connected to the liquid inlet of the first nebuliser, so that an eluate obtained by means of the liquid chromatography system as the flavouring substance preparation can be fed through liquid inlet of the first nebuliser.

6. The device according to claim 5, wherein between the liquid chromatography system and the first nebuliser a detector for detection of the flavouring substance(s) in the eluate is arranged.

7. A method for producing a liquid flavouring substance condensate suitable for sensorial assessment of amplifying or reducing flavouring substance characteristics by a test person containing or consisting of the following steps:
a. provision of a liquid flavouring substance preparation, containing or consisting of one or more flavouring substances, water and/or ethanol, and an inert gas,
b. provision of a liquid reference preparation, containing or consisting of one or more reference substances, water and/or ethanol, as well as an inert gas,
c. feeding of the liquid flavouring substance preparation from step a) through a liquid inlet and the inert gas through a gas inlet into a first nebuliser by means of which the flavouring substance preparation and the inert gas are nebulised into an aerosol and in this way fed into a mixing chamber,
d. feeding of the liquid reference preparation from step b) through a liquid inlet and the inert gas through a gas inlet into a second nebuliser by means of which the reference preparation and the inert gas are nebulised into an aerosol and in this way fed into a mixing chamber,
e. conversion of part or all of the ethanol content of the aerosols fed into the mixing chamber in step d) by means of an evaporator into a gas phase,
f. passing of the aerosol formed in step e) into a separation chamber connected to the mixing chamber and with a gas outlet and removal of part or all of the gaseous ethanol content from the separation chamber through the gas outlet,
g. passing of the aerosol formed in step f) into a condensation chamber connected to the separation chamber and with a liquid outlet and a condenser and condensation of the aerosol by means of the condenser into a flavouring substance condensate containing or consisting of the flavouring substance(s), the reference substance(s), water and/or ethanol and
h. removal of the flavouring substance condensate formed in step g) from the condensation chamber through the liquid outlet.

8. The method according to claim 7, wherein the flavouring substance preparation, fed into the first nebuliser in step a) is an eluate obtained by means of a liquid chromatography system.

9. The method according to claim 8, wherein the eluate from the liquid chromatography system is investigated by means of a detector, arranged between the liquid chromatography system and the first nebuliser, for the presence of a flavouring substance in the eluate.

10. The method according to claim 7, wherein, in step c) a flavouring substance preparation with an ethanol content of >15% by weight with reference to the total weight of the flavouring substance preparation is fed into the first nebuliser and in step d) a reference preparation without ethanol or with a sufficiently low ethanol content is fed into the second nebuliser, so that the liquid flavouring substance condensate removed in step h) has an ethanol content of ≦15% by weight with reference to the total weight of the flavouring substance condensate.

11. A method for sensorial assessment of the amplifying and/or reducing taste impressions of one or more flavouring substances containing or consisting of the following steps:
i. production of a liquid flavouring substance condensate containing or consisting of one or more flavouring substances, one or more reference substances, water and/or ethanol according to the method according to claim 7 and
ii. introduction of the flavouring substance condensate from step i) into the mouth of a test person for sensorial assessment of amplifying and/or reducing taste impressions.

12. A method for producing a liquid flavouring substance condensate containing or consisting of one or more flavouring substances, one or more reference substances, water and/or ethanol comprising providing a liquid flavouring substance preparation to the device according to claim 1.

13. A method for diluting a liquid flavouring substance preparation containing or consisting of the following steps:
a) provision of a liquid flavouring substance preparation, containing or consisting of one or more flavouring substances, water and ethanol with an ethanol content of >15% by weight with reference to the total weight of the flavouring substance preparation, and an inert gas,
b) provision of a diluent, containing or consisting of water and/or ethanol, wherein the ethanol content is ≦15% by weight with reference to the total weight of the solution, and an inert gas,
c) feeding of the liquid flavouring substance preparation from step a) through a liquid inlet and of the inert gas through a gas inlet into a first nebuliser by means of which the flavouring substance preparation and the inert gas are nebulised into an aerosol and in this way fed into a mixing chamber,
d) feeding of the diluent from step b) through a liquid inlet and of the inert gas through a gas inlet into a second nebuliser by means of which the diluent and the inert gas are nebulised into an aerosol and in this way fed into the mixing chamber,
e) conversion of part or all of the ethanol content of the aerosols fed into the mixing chamber in step d) by means of an evaporator into a gas phase,
f) passing of the aerosol formed in step e) into a separation chamber connected with the mixing chamber and with a gas outlet and removal of part or all of the gaseous ethanol content from the separation chamber through the gas outlet,
g) passing of the aerosol formed in step f) into a condensation chamber connected with the separation chamber and with a liquid outlet and condenser and condensation of the aerosol by means of the condenser into a flavouring substance condensate containing or consisting of the flavouring substance(s), water and ethanol, wherein the ethanol content is ≦15% by weight with reference to the total weight of the condensate and
h) removal of the flavouring substance condensate formed in step g) from the condensation chamber via the liquid outlet.

14. A method for sensorial assessment of one or more flavouring substances containing or consisting of the following steps:
i. production of a liquid flavouring substance condensate containing or consisting of one or more flavouring substances, water and ethanol according to claim 13, wherein the ethanol content is ≦15% by weight with reference to the total weight of the condensate, and
ii. introduction of the flavouring substance condensate from step i) into the mouth of a test person for sensorial assessment of the flavouring substance(s).

15. A method for the production of a liquid flavouring substance condensate containing or consisting of one or more flavouring substances, water and ethanol, wherein the ethanol content is ≦15% by weight with reference to the total weight of the condensate comprising providing a liquid flavouring substance containing or consisting of one or more flavouring substances, water and ethanol to the device according to claim 1.

16. The device according to claim 2, wherein the first nebuliser and/or second nebulizer is operated at a temperature between 10 and 40° C.

17. The device according to claim 3, wherein the gas inlet of the first and/or second nebuliser has a controller for adjusting a working pressure in the nebuliser in the range from 1 to 4 bar.

18. The device according to claim 4, wherein the liquid inlet of the first and/or second nebuliser has a controller for adjusting the feed rate of the liquid into the nebuliser in the range from 2 to 4 ml/min.
